(19) United States
(12) Patent Application Publication
(10) Pub. No.: US 2019/0130874 A1
(43) Pub. Date: May 2, 2019

(54) PORTABLE EMOJI/IMAGE DISPLAY DEVICE

(71) Applicant: Rigel Craft, LLC, Oklahoma City, OK (US)

(72) Inventor: Clyde W. Wafford, Oklahoma City, OK (US)

(73) Assignee: Rigel Craft, LLC, Oklahoma City, OK (US)

(21) Appl. No.: 16/177,921

(22) Filed: Nov. 1, 2018

Related U.S. Application Data
(60) Provisional application No. 62/580,815, filed on Nov. 2, 2017.

(51) Int. Cl. G09G 5/373; G06K 9/00; G10L 25/63; G09G 5/02; G06F 1/16; B60R 11/02; B60Q 1/50

(52) U.S. Cl. CPC G09G 5/373; G09G 2330/02; G10L 25/63; G09G 5/02; G06F 1/1626; G06F 1/1635; B60R 11/0229; B60Q 1/50; G09G 2354/00; G09G 2380/10; G09G 2340/04; G09G 2320/066; G09G 2320/0666; G09G 2320/0626; G09G 2360/144; G06K 9/00315

(57) ABSTRACT

An exemplary mobile display device includes a memory device for storing an emoji/image library, a user interface for receiving input data from a user, and a display device for displaying an emoji/image stored in the library. The display device also includes a processor for selecting the emoji/image stored in the library for display. The processor is configured to select the emoji/image based on voice and/or image input by the user via the user interface, and compare patterns of the input voice and/or image with reference voice and/or image data stored in the memory device

### FIELD

The present disclosure is directed to a digital display device, and more particularly to a device for displaying an emoji/image.

### BACKGROUND

The use of social media is prevalent throughout many facets of society. People are spending much of their time interacting with friends, family, and strangers through social media applications. Social media provides a manner of free expression, where one can post ideas for comment by others or comment on the posts of others. In some ways, social media has become therapeutic for some in that it can allow a person to detach or escape from the rigors of daily life and freely express their feelings or thoughts. Emoticons, emojis, characters, and/or images are sometimes used as a tool by which feelings or thoughts are expressed on social media. Many social media applications require users to actively provide an input. However, not many applications and/or devices allow for passive input by a user and allow the user to interact or communicate with those in the immediate vicinity or area including on roads, streets, paths, or highways.

### SUMMARY

An exemplary mobile display device is disclosed. The mobile display device comprising: a housing; and a holder attached to the housing for mounting the display device to an interior of a vehicle, the housing including: a plurality of sensors for detecting characteristics of an environment around the vehicle; a memory device for storing an image library; a user interface for receiving input data from a user; a display screen for displaying an image stored in the library; and a processor for selecting the image stored in the library for display, the processor being configured to select the image based on voice and/or image input by the user via the user interface, compare patterns of the input voice and/or image with reference voice and/or image data stored in the memory device, and adjust characteristics of the displayed image based on environmental data received from one or more of the plurality of sensors.

An exemplary mobile display system is disclosed. The mobile display system, comprising: a housing; and a holder attached to the housing for mounting the display device to an interior of a vehicle the housing including: a plurality of sensors for detecting characteristics of an environment around the vehicle; a memory device for storing an image library; a user interface for receiving input data from a user; a display screen for displaying an image stored in the library; and a first processor configured to process the received input data to generate an electronic data pattern, the processor configured to send the data pattern to a second processor for identifying an image associated with the data pattern, and receive from the second processor an identifier associated with an image stored in the library and selected for display on the display screen.

### BRIEF DESCRIPTION OF THE DRAWING FIGURES

The scope of the present disclosure is best understood from the following detailed description of exemplary embodiments when read in conjunction with the accompanying drawings, wherein:

FIG. 1 illustrates an overview of a display device in accordance with an exemplary embodiment of the present disclosure.

FIG. 2 illustrates a front panel of a display device in accordance with an exemplary embodiment of the present disclosure.

FIG. 3 illustrates a back panel of a display device in accordance with an exemplary embodiment of the present disclosure.

FIG. 4 illustrates a top view of a display device in accordance with an exemplary embodiment of the present disclosure.

FIG. 5 illustrates a bottom view of a display device in accordance with an exemplary embodiment of the present disclosure.

FIG. 6A illustrates a display device holder in accordance with an exemplary embodiment of the present disclosure.

FIG. 6B illustrates a mobile display device mounted in a vehicle in accordance with an exemplary embodiment of the present disclosure.

FIG. 7 illustrates a first remote control device for the display device in accordance with an exemplary embodiment of the present disclosure.

FIG. 8 illustrates a second remote control device for the display device in accordance with an exemplary embodiment of the present disclosure.

FIG. 9 is a flow chart illustrating a method for emotion recognition in accordance with an exemplary embodiment of the present disclosure.

FIG. 10 is a flow chart illustrating a method for displaying an emoji/image in accordance with an exemplary embodiment of the present disclosure.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

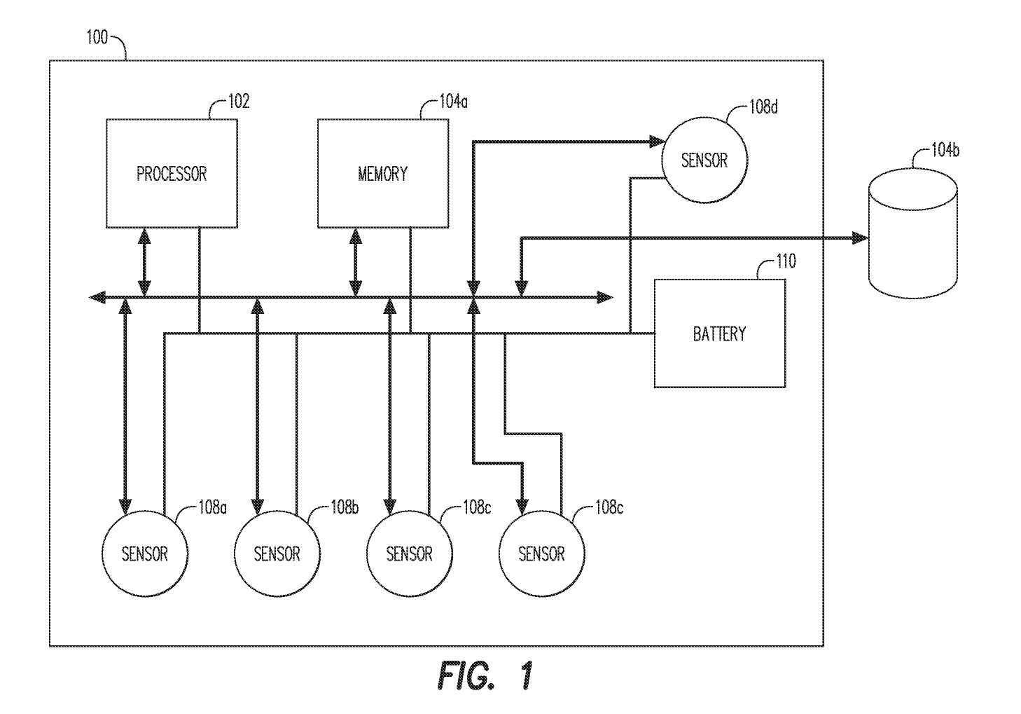

Exemplary embodiments of the present disclosure are directed to a device that displays an emoji/image on a screen from inside of a vehicle attached to a window of the vehicle, see FIG. 1, based on the emotion recognition and/or voice command of the driver. The display device can display any number of emojis/images. The display device displays the emojis/images so that the emojis/images are clearly visible and discernable (e.g., large enough and bright enough) so other vehicles, motorists, or pedestrians can see them displayed on the screen. The screen would point outward from the car so others could see it. Using emotion and voice recognition the system can determine the emotional state of the driver and display the emoji/image related to the emotion. The emotion would be determined by the facial expressions of the driver along with voice analysis of the driver. The display device can use one or both of facial expressions and voice analysis to determine the driver's emotional state and display a matching emoji/image. The purpose is so a driver in a car can display emojis/images to other motorists. The display device can display a Smiling emoji/image, an Angry emoji/image, a love emoji/image, etc. The display device and system as described herein can provide a unique way for a user or driver to passively communicate and/or interact with other drivers by displaying information related to the driver's current emotional state.

FIG. 1 illustrates an overview of a display device in accordance with an exemplary embodiment of the present disclosure. As shown in FIG. 1, the display device 100 can include a processor 102, memory 104, a one or more sensors 108, and a battery 110. The processor 102 can be configured to execute one or more software modules for displaying an emoji/image. The memory 104 includes on-board memory device 104a and can also be configured to include a remote memory device 104b such as a database in combination with the on-board memory device 104a. The on-board memory device 104a can store programming code, user data, an emoji/image lookup table, and/or an emoji/image library. The data structure can be formatted such that each emoji/image is associated with a unique numerical value and/or a name for identifying the emoji/image. The emojis/images can be indexed in the data structure in any desirable order (e.g., numerically, alphabetically, use frequency, etc.). The processor 102 can be connected to the remote memory device 104b via a network and associated network interface. The programming code can include an operating system and a plurality of software modules 106 that are executed by the processor 102. The one or more software modules 106 can be stored in memory 104 and configured to control various operations of the display device 100. For example, the operating system can execute a software module 106 can be executed by the processor 102 upon command by the operating system or upon command by a user. For example, the display device 100 can be configured to display a screen having a plurality of embedded links or buttons displayed thereon. The links can be activated via voice (e.g., touchless) or physical interaction (e.g., touch) with the display screen 100. According to an exemplary embodiment, the display device 100 can be connected to a server and/or other computing devices on the network. The display device 100 can be configured to transmit any image or sound data obtained from the driver/user to the server or other computing device for generating the data patterns and storage in the database.

The display device 100 can also include one or more sensors 108 for interacting with the environment. For example, the one or more sensors 108 can include a light sensor, a microphone, distance detector, and solar panels or any other detection device as desired. The light sensor can be used to detect light from the environment. Based on the amount of light detected, the processor 102 can be configured to adjust the brightness and /or contrast of the display. The one or more sensors 108 can also include a distance sensor which is configured to measure the distance an oncoming car traveling in the opposite direction or a leading or forward vehicle traveling in the same direction is from the display device 100. The distance detection can involve any type of radar technology for determining range, angle, and/or the velocity of objects. For example, the distance sensor can include a radar transmitter and receiver. The transmitter can be configured to emit radio waves and the receiver can be configured to receive signals reflected from an oncoming car, a pedestrian or other object in or near a roadway. The distance sensor or the processor 102 can determine a distance and/or velocity of the object by processing the reflected signals. Based on the detected distance of the nearest oncoming or forward vehicle, motorist, or pedestrian the display device 100 via the processor 102 can be configured to change the image size by enlarging or shrinking the image to improve visibility and viewing. The detected distance can be associated with an appropriate display size using a look-up table stored in memory 104 or compared to a threshold or threshold range, where the size of the image is adjusted if it is above or below the specified range. For example, if a vehicle or pedestrian is detected to be more than 20 feet from the display device, then the image can be enlarged to the largest size possible. The size of the image can be reduced as the vehicle and/or pedestrian moves closer to the display device. Still further, the one or more sensors 108 can include solar panels configured to detect solar light and convert the solar light to electric power for charging the battery 110.

The battery 110 can be used to provide power to the display device 102. The battery 110 can be configured to hold a single charge, or can be rechargeable and configured for multiple charging operations (i.e., recharging). The rechargeable battery 110 can be configured for recharging through AC power received from a standard power outlet or can be configured to receive power from the solar panels.

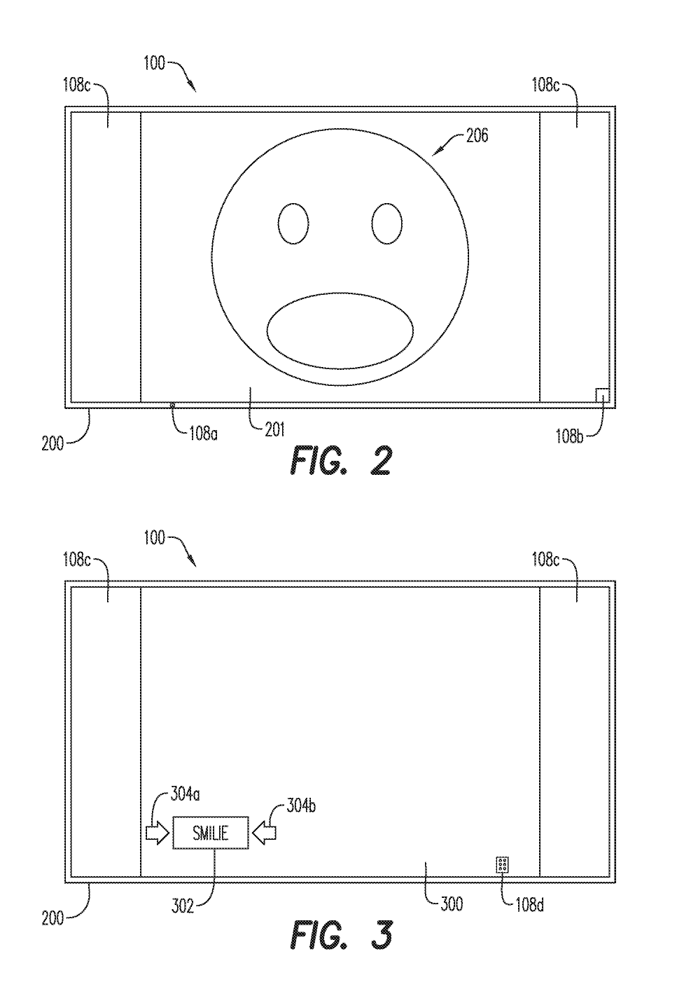

FIG. 2 illustrates a front panel of a display device in accordance with an exemplary embodiment of the present disclosure. As shown in FIG. 2, the display device 100 includes a device housing or frame 200 that having a front panel 201. The device housing 200 houses the other device components illustrated and discussed relative to FIG. 1. The front panel 201 of the display device 100 can include a display panel or screen 204 for displaying an emoji/image 206 and any other graphics for interaction with a user. The front panel display screen 204 can be in form of a touchscreen having a resistive, capacitive, or infrared grid construction or any other suitable construction as desired. For example, the housing 200 can include positions for one or more of the sensors 108, such as the light sensor 108a, a distance indicator 108b, and solar panels 108c. FIG. 2 shows exemplary installation positions for the sensor components within the housing 200. It should be understood that the sensors can be installed in any location on the device that is suitable for the device to perform the desired detection function.

FIG. 3 illustrates a back panel of a display device in accordance with an exemplary embodiment of the present disclosure. As shown in FIG. 3, the device housing or frame 200 includes a back panel 300. The back panel 300 includes a display screen 302 that indicates which emoji/image is being displayed on the front panel display screen 204 on the front panel. The back panel display screen 302 can be implemented as a liquid crystal display or light emitting diode display panel or any other suitable display as desired. The back panel 300 can also include one or more buttons 304a, 304b associated with the back panel display screen 302. The buttons 304a, 304b can be used to change the emoji/image 206 that is displayed on the front panel display screen 204. For example, the buttons 304a, 304b can be configured to advance through a list of stored emoji/images in a forward (e.g., next) or backward (e.g., previous) direction, respectively until the name of a desired emoji/image is shown. The back panel 300 can also include one or more sensors 108, such as a microphone 108d. The microphone 108d can be used by the driver/user to deliver voice prompts and/or commands for controlling the display device 100 to perform a desired function or display a desired emoji/image.

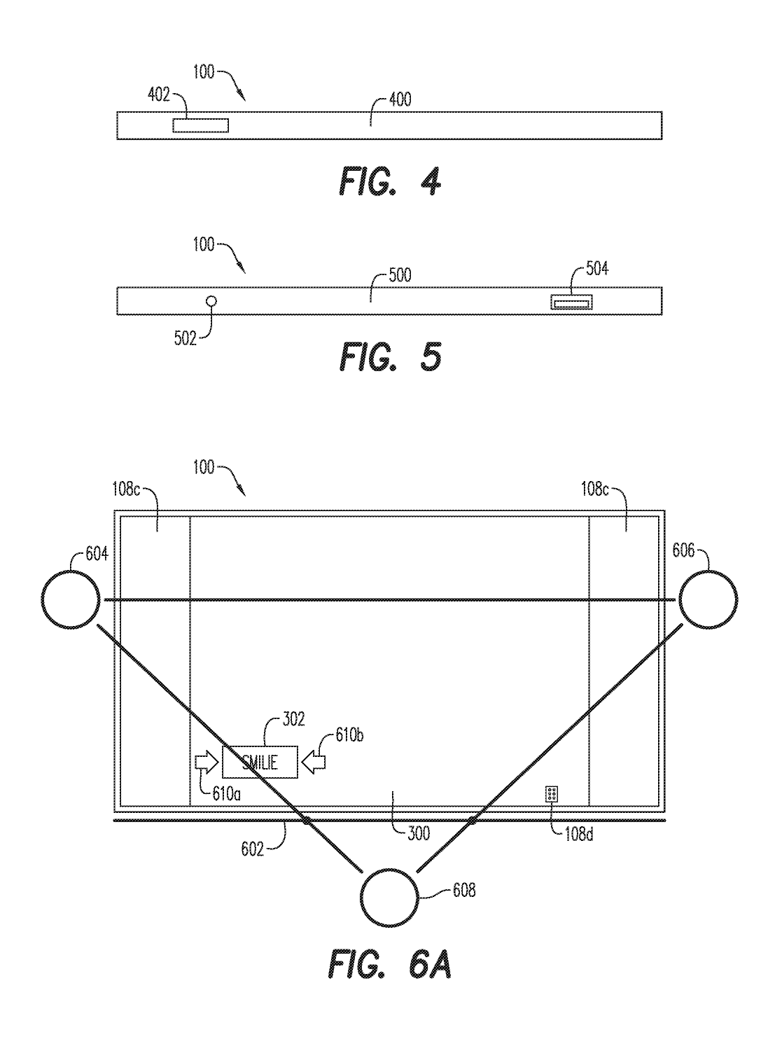

FIG. 4 illustrates a top view of a display device in accordance with an exemplary embodiment of the present disclosure. As shown in FIG. 4, the top 400 of the device housing or frame 200 can include a power button 402 for placing the display device 100 in a powered “ON” or “OFF” state. The button can be in any form suitable for depression and/or switching to select the specified power state as desired.

FIG. 5 illustrates a bottom view of a display device in accordance with an exemplary embodiment of the present disclosure. As shown in FIG. 5, a bottom side 500 of the device housing 200 or frame can in include a power port 502 for receiving an adaptor of a power cord for supplying the display device 100 with power from a power source. The bottom side 500 of the device housing 200 can also include a Universal Serial Bus (USB) port 504 for receiving an adaptor of a USB device that communicates data and/or supplies power to the display device 100. It should be understood that any suitable ports or receptacles can be used for supplying any of power and/or data to the display device 100 as desired.

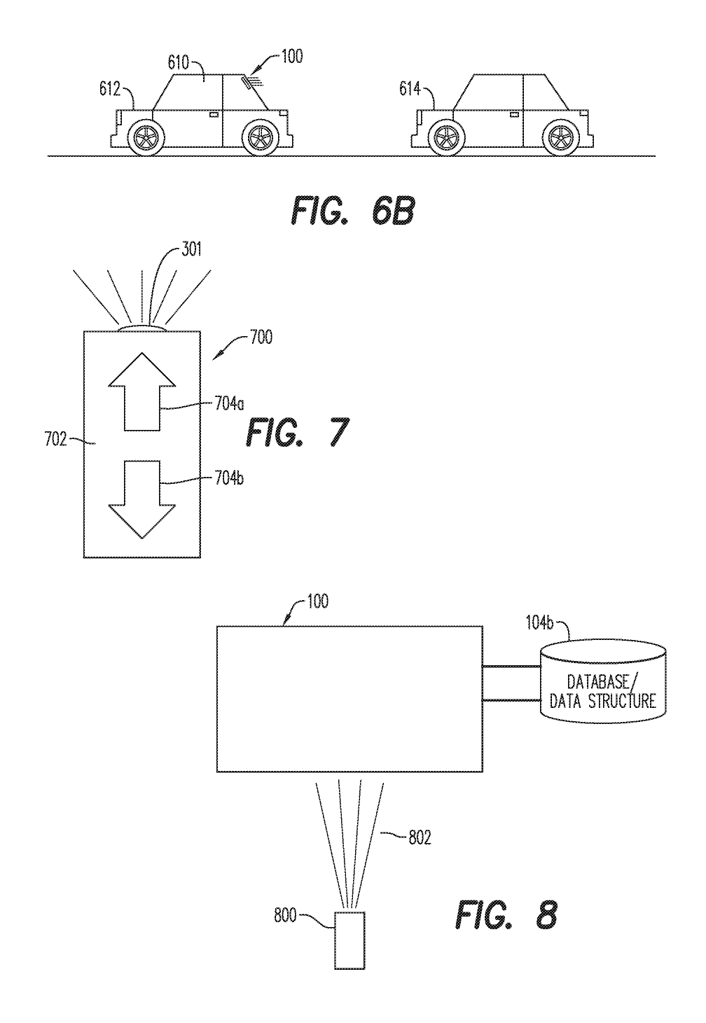

FIG. 6a illustrates a display device holder in accordance with an exemplary embodiment of the present disclosure. As shown in FIG. 6a, the display device holder 600 can include an attachment frame 602 with at least three points 604, 606, 608 for attachment. The attachment frame 602 can be attached to the back panel 300 of the display device 100 through any of screws, adhesive tape, glue, or any other attachment means as necessary. The attachment points 604, 606, 608 can be connected to an external surface of a vehicle, wall, door, or any other suitable surface as desired. The attachment points 604, 606, 608 can be configured to attach to the external surface via suction means, such as through suction devices, or adhesive means, such as tape or glue or any other suitable adhesive as desired.

FIG. 6b illustrates a mobile display device mounted in a vehicle in accordance with an exemplary embodiment of the present disclosure. As shown in FIG. 6b, the display device 100 can be mounted in the interior 610 of a vehicle 612. For example, display device 100 could be secured or attached to a door window, the front window, or back window. When the display device 100 is installed in the attachment frame 602, which is mounted in a vehicle, the back panel 300 of the display device 100 faces the driver. As a result, if on the front panel screen 204 the Smile emoji/image is displayed, then on the back panel screen 302 showing the word “Smile” or identifier for the Smile emoji/image will be displayed so that the driver is aware of the emoji/image or emoticon being publicly displayed to persons outside of the vehicle (e.g., other vehicles, motorists, pedestrians, etc.). When the emoji/image is displayed will be large on the screen, taking up 65% to 90% of screen space. Moreover, the processor 102 can be configured to adjust the brightness, color, and/or contrast of the front panel display screen 204 in response to environmental data detected by the one or more sensors. For example, in the event the one or more sensors 108 detects ambient light that is above a threshold score of 50, the processor 102 can adjust the brightness level and/or contrast level and/or color of the emoji/image so that it can be clearly seen by the public or other leading or passing vehicles 614. For example, the memory 104 stores tables that associate the measure of ambient light to an appropriate contrast, brightness, and/or color for visibility and viewing. The amount of detected light can be associated with the appropriate display characteristics via a look-up table or list or other suitable data structure stored in memory 104

FIG. 7 illustrates a remote control for the display device in accordance with an exemplary embodiment of the present disclosure. As shown in FIG. 7, the remote control 700 can be configured as a wireless transmitter for sending command signals to the display device 100. The remote control 700 can having a housing 702 with one or more buttons 704a, 704b associated with the display screen 302 of the back panel 300. The buttons 704a, 704b can be used to change the emoji/image 204 that is being shown on the screen 204 of the front panel 200. The buttons 704a, 704b can be configured to advance through a list of stored emoji/images in a forward (e.g., next) or backward (e.g., previous) direction, respectively until the name of a desired emoji/image is shown. The remote control 700 can be configured to use any wireless communication technology including Bluetooth, radio frequency (RF) signals, cellular, or any other suitable wireless communication format as desired.

FIG. 8 illustrates a remote control device for the display device in accordance with an exemplary embodiment of the present disclosure. According to an exemplary embodiment, the display device 100 can be remotely controlled via a smart electronic device 800, such as a smartphone or other portable/mobile electronic device configured for wireless communication with the display device 100 over Bluetooth 802 or other suitable wireless network. The mobile electronic device can be programmed with software modules (e.g., applications or apps) for executing a remote control application that controls the display device 100. When executed on the mobile electronic device 800 the app will have a graphical user interface (GUI) that enables the user to control various functions of the display device 100 and/or configure the data structure and settings of the display devices as needed. Using both voice command and/or emotion recognition the app and device can then trigger and display the proper emoji/image that represents the driver's emotion. The app would allow emoji/image to be uploaded to the mobile device 800 so that each user can customize any number of desired emojis/images for display. The display device 100 and/or the app can be configured to store a default set of emojis/images upon initial activation. The display device 100 and the mobile electronic device 800 can be securely linked and/or synced via the app. For example, the app can includes a secure Device/Password so once setup by a user no other user with a mobile app can control the display device 100. According to an exemplary embodiment, the mobile electronic device 800 can be connected to the USB port 504 of the display device 100 via a USB cable. Once connected the user can sync up emoji/images/images stored on the mobile electronic device 800 to the system, update the emoji/image database structure which will have training information for voice command and emotion recognition, and configure other system settings as desired.

According to an exemplary embodiment, the processor 102 can execute at least one of the plurality of software modules stored in memory 104 so that a user can train the display device to recognize his emotional state based on the facial expression and/or voice pitch, tone, sound and words. Emotion recognition can be similar to a voice command, as the user can train the software module to recognize certain emotions (either facially or aurally), convert the image and/or sound to data points and/or a data pattern, and then associate the data points or data pattern with a specific emoji/image. These patterns can be stored in on-board memory 104a in various formats, such as, an array, list, look-up table or other suitable data structure. In addition or as an alternative to storing the patterns in on-board memory 104a, as already discussed an external or remote database 104b can be used to store the emoji/image items. Training the software module will link the user's emotion/voice to certain emoji/images/images. When the memory device 104, 105 links with the display device 102 it will sync up the data structure of information collected during training.

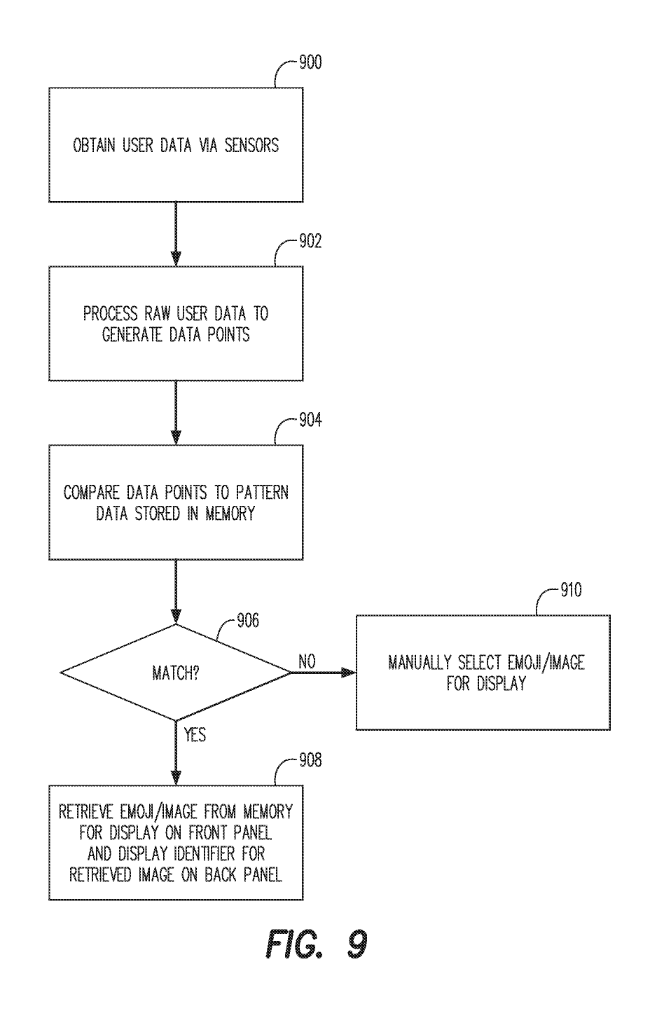

FIG. 9 is a flow chart illustrating a method for emotion recognition in accordance with an exemplary embodiment of the present disclosure. In a step 900, one or more of the sensors 108 of the display device 102 can obtain an image of the user's face or the sound of a user's voice. According to an exemplary embodiment, the display device 100 can be configured to obtain the image at specified time intervals. For example, the processor 102 can be configured to control an image sensor 108 to capture an image at 1, 5, 15, or 30 minute intervals or any other timing interval as desired. The processor 102 processes the raw image and/or sound data, which can include vehicle noise and other ambient or background sounds in the environment, and any ambient or artificial lighting. The processing performed by the processor 102 can include converting the received image and/or sound information into digital data points that represent the driver's emotional state (step 902). Using the data points, the processor accesses the memory 104 in search of a matching data pattern by comparing the data points to pre-stored emotion data pattern of the user (step 904). If a match is found, then the processor 102 identifies the emoji(s)/image(s) associated with the data match, retrieves the emoji/image from memory, and displays the retrieved emoticon the display device (step 906). From the software module the user can also change the emoji/images/images on the front panel display screen 204. The back panel screen 302 will be updated to display the name or identifier associated with the emoticon displayed on the front panel display screen 204 (step 908). According to an exemplary embodiment, the user can override any emoji/image selected by the processor for display by selected the desired emoticon via the buttons 304a, 304b on the back panel 300 the one or more buttons 704a, 704b on the remote control 700, or via the app executed on the mobile electronic device 800. If a match is not found, the user is notified by a sound or alert and a corresponding message is displayed on the back panel display screen 302 and the user may manually select an emoji/image for display (910). The driver/user may then manually select an emoji to be displayed on the front panel display screen 204. According to another exemplary embodiment, the user can use a voice command. The voice command can be captured by a microphone 108d and processed by the processor 102 via the one or more software modules so that the display device 100 displays a desired emoji/image on the front panel display screen 204. The display device 100 can be configured to scan a driver's face, and then match the face to an emotion expression found within memory with a high degree of certainty. The processor 102 determines whether the match is a likely match based on a threshold value or score it associates with the matched data based on the number of matching data points. For example, a match above a threshold of 70% is suitable for display.

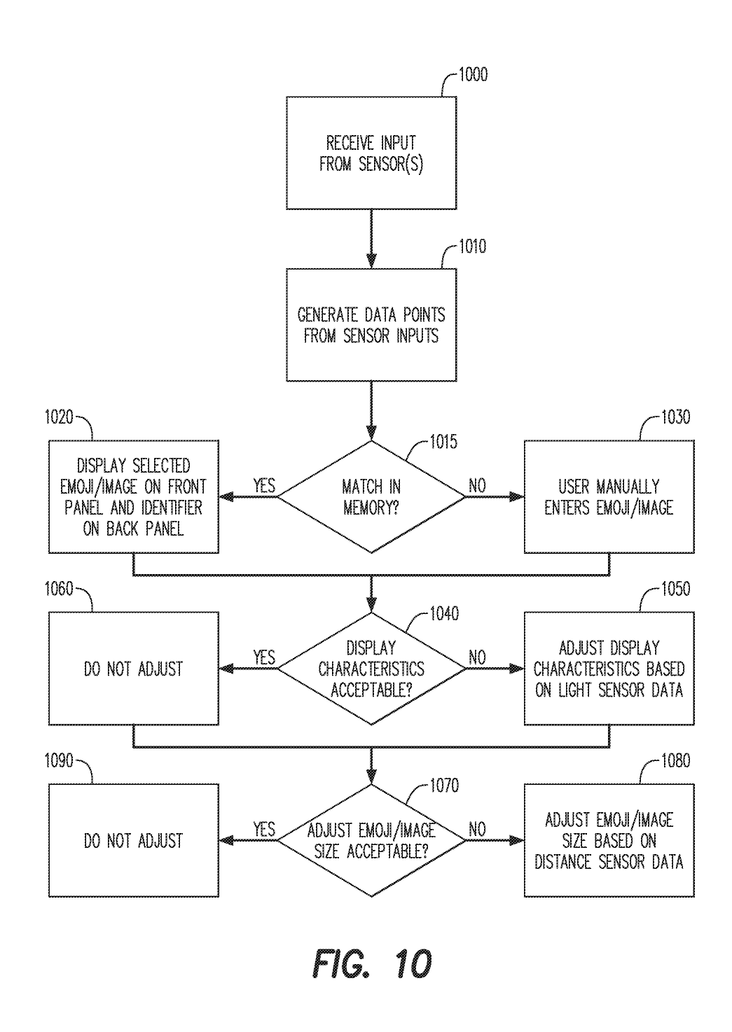

FIG. 10 is a flow chart illustrating a method for displaying an emoji/image in accordance with an exemplary embodiment of the present disclosure. As shown in FIG. 10, the display device 100 can receive an input from one or more of the sensor 108, the one or more buttons 304a, 304b on the back panel 300, the remote control 700, or the mobile electronic device 800 (step 1000). If the input is received from the one or more sensors 108, the processor 102 processes the received data to generate data points for comparison with data patterns stored in memory 104 (1010). If the processor 102 finds a match, the identified emoji/image is obtained from memory 104 and displayed on the front panel screen 204 (1015, 1020). The processor 102 will also update the back panel display screen 305 to display the name or identifier associated with the emoji/image or image displayed on the front panel display screen 204. If the processor 102 does not find a match, the user may manually select an emoji/image for display (1015, 1030). The processor determines 102 whether the display characteristics (e.g., contrast, color, and brightness levels) of the front panel display screen 204 are suitable for visibility or viewing by the public based on the amount of light detected by the light sensor (1040). Based on the amount of light detected, the processor 102 can determine whether the display characteristic should be adjusted to improve visibility of the image. If the display characteristics are not appropriate for the amount of light detected, then the processor 102 adjusts the display characteristics of the front panel display screen 202 based on data stored in memory (1050). If the display characteristics are at the proper setting for the amount of detected light, then no adjustments are made (1060). The processor 102 determines whether the display size of the emoji/image on the front panel display screen 204 is appropriate based on the distance from an approaching vehicle, motorist, or pedestrian based on data detected from the distance sensor (1070). If the display size is not appropriate for the distance detected then the processor 102 adjusts the display size of the emoji/image on the front panel display screen 204 (1080). If the processor 102 determines that the display size is appropriate for the detected distance, then no adjustment is made (1090).

According to an exemplary embodiment, the methods described herein can be at least partially processor-implemented in the display device 100 or in a remote processing device, or a combination thereof. For example, at least some of the operations of a method can be performed by one or more remote processors or processor-implemented circuits. The performance of certain of the operations can be distributed among the one or more processors, not only residing within a single machine or device, but deployed across a number of devices. For example, the processor or processors can be located in a single location (e.g., within a home environment, an office environment or as a server farm), while in other examples the processors can be distributed across a number of locations.

The display device can include one or more which can also operate to support performance of the relevant operations in a “cloud computing” environment or as a “software as a service” (SaaS). For example, at least some of the operations can be performed by a group of mobile or stationary computers (as examples of devices including processors), with these operations being accessible via a network (e.g., the Internet) and via one or more appropriate interfaces (e.g., Application Program Interfaces (APIs).) The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

Exemplary embodiments (e.g., apparatus, systems, or methods) can be implemented in digital electronic circuitry, in computer hardware, in firmware, in software, or in any combination thereof. Example embodiments can be implemented using a computer program product (e.g., a computer program, tangibly embodied in an information carrier or in a machine readable medium, for execution by, or to control the operation of, data processing apparatus such as a programmable processor, a computer, or multiple computers).

A computer program can be written in any form of programming language, including compiled or interpreted languages, and it can be deployed in any form, including as a stand-alone program or as a software module, subroutine, or other unit suitable for use in a computing environment. A computer program can be deployed to be executed on one computing device or on multiple computing devices at one site or distributed across multiple sites and interconnected by a communication network.

According to an exemplary embodiment, operations can be performed by one or more programmable processors executing a computer program to perform functions by operating on input data and generating output. Examples of method operations can also be performed by, and example apparatus can be implemented as, special purpose logic circuitry (e.g., a field programmable gate array (FPGA) or an application-specific integrated circuit (ASIC)).

The emoji/image display can encompass a system including clients and servers. A client and server are generally remote from each other and generally interact through a communication network. The relationship of client and server arises by virtue of computer programs running on the respective computing devices and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice.

Data stored for use in the display system described herein can be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The display system and display device can include a display interface that may be configured to allow data to be transferred between the display device and an external display. Exemplary display interfaces may include high-definition multimedia interface (HDMI), digital visual interface (DVI), video graphics array (VGA), etc. The display device can include any suitable type of display for displaying data transmitted via the display interface of the mobile device, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the memory device, which may be memory semiconductors (e.g., DRAMs, etc.). These computer program products may be means for providing software to the mobile device or display system. Computer programs (e.g., computer control logic) may be stored in the memory device. Computer programs may also be received via the communications interface. Such computer programs, when executed, may enable display system or mobile device to implement the present methods as discussed herein. In particular, the computer programs, when executed, may enable processor device to implement the methods as discussed herein. Accordingly, such computer programs may represent controllers of the display system. Where the present disclosure is implemented using software, the software may be stored in a computer program product and loaded into the mobile device of the display system using a removable storage drive, an interface, a hard disk drive, or communications interface, where applicable.

According to an exemplary embodiment, the display system can include a processing server that communicates image or sound data with the database, mobile device, and/or display device. The processing server can be configured to perform the functions discussed herein as will be apparent to persons having skill in the relevant art. In some embodiments, the processing server may include and/or be comprised of a plurality of engines and/or modules specially configured to perform one or more functions.

The processing server may comprise a memory. The memory may be configured to store data for use by the processing server in performing the functions discussed herein. The memory may be configured to store data using suitable data formatting methods and schema and may be any suitable type of memory, such as read-only memory, random access memory, etc. The memory may include, for example, encryption keys and algorithms, communication protocols and standards, data formatting standards and protocols, program code for application programs, rules and algorithms for performing voice and image analysis and recognition, and other data that may be suitable for use by the processing server in the performance of the functions disclosed herein as will be apparent to persons having skill in the relevant art.

While the exemplary embodiments have been described in the context of displaying emojis/images, it should be understood and readily apparent to one of ordinary skill in the art that the system can be configured to display any image, text, picture, video, graphic, or other visual output useful for conveying a message regarding the mood and/or emotion of the user. For example, images of nature, pets, vehicles, people, places, landmarks, events, words, phrases, symbols, or other suitable images as desired can be stored in memory and selected by the mobile device or display system for output or display on the display device.

It will thus be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A mobile display device, comprising:
a housing; and
a holder attached to the housing for mounting the display device to an interior of a vehicle the housing including:
a plurality of sensors for detecting characteristics of an environment around the vehicle;
a memory device for storing an image library;
a user interface for receiving input data from a user;
a display screen for displaying an image stored in the library; and
a processor for selecting the image stored in the library for display, the processor being configured to select the image based on voice and/or image input by the user via the user interface, compare patterns of the input voice and/or image with reference voice and/or image data stored in the memory device, and adjust characteristics of the displayed image based on environmental data received from one or more of the plurality of sensors.

2. The mobile display device according to claim 1, comprising:
a rechargeable battery for supplying power to device components.

3. The mobile display device according to claim 2, comprising:
solar panels for providing electric charge to the rechargeable battery.

4. The mobile display device according to claim 1, comprising:
a mount for mounting the display device in an interior cabin of a vehicle.

5. A mobile display device, comprising:
a housing; and
a holder attached to the housing for mounting the display device to an interior of a vehicle the housing including:
a plurality of sensors for detecting characteristics of an environment around the vehicle;
a memory device for storing an image library;
a user interface for receiving input data from a user;
a display screen for displaying an image stored in the library; and
a first processor configured to process the received input data to generate an electronic data pattern, the processor configured to send the data pattern to a second processor for identifying an image associated with the data pattern, and receive from the second processor an identifier associated with an image stored in the library and selected for display on the display screen.

6. The mobile display system according to claim 5, wherein the first processor is configured to adjust characteristics of the displayed image based on environmental data received from one or more of the plurality of sensors.

7. The mobile display system according to claim 6, wherein the first processor is configured to adjust a display characteristic of the displayed image by adjusting one or more of a contrast, brightness, and color based on the amount of light detected by a light sensor.

8. The mobile display system according to claim 6, wherein the first processor is configured to adjust a size of the displayed image based on a distance a vehicle is from a distance detection sensor.

9. A method for displaying an image on a mobile device mounted inside a vehicle, the method comprising:
obtaining biometric data from a user;
generating a digital data pattern from the biometric data;
comparing the digital data pattern to a second data pattern stored in memory;
identifying an image associated with the second data pattern;
displaying the identified image on a display screen; and
adjusting a display characteristic of the displayed image based environmental data associated with the vehicle.

10. The method according to claim 9, wherein adjusting the display characteristic comprises:
receiving data associated with an amount of detected light from a light sensor on the mobile device;
comparing the received data with a threshold value;
adjusting one or more of a contrast, brightness, and color if the received data is above a predetermined threshold.

11. The method according to claim 9, wherein adjusting the display characteristic comprises:
receiving data indicating a distance of a vehicle or pedestrian from the mobile device;
comparing the received data with a threshold value;
adjusting a size of the displayed image if the distance is above or below a predetermined threshold.
